(19) United States
(12) Patent Application Publication
(10) Pub. No.: US 2007/0086880 A1
(43) Pub. Date: Apr. 19, 2007

(54) Personal lift apparatus

(76) Inventor: Mark Jordan, Houston, TX (US)

Correspondence Address: JOHN K. BUCHE, 7777 FAY AVENUE, SUITE 205, LA JOLLA, CA, 92037, US

(21) Appl. No.: 11/249,879

(22) Filed: Oct. 14, 2005

(51) Int. Cl. B65G 47/91

(52) U.S. Cl. 414/630

(57) ABSTRACT

A personal lift apparatus that operates by pneumatic or hydraulic means to move an ambulatory individual from a position on a floor to an upright position and vice-versa, and which lift apparatus features upper and lower frame members, with the upper frame member having a seat for the user.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention

The present invention relates to the field of personal lift devices for raising and lowering ambulatory and other individuals by assisted means.

2. Description of Prior Art

There are many individuals who suffer from limited mobility by reason of disease, advanced age or disability. A common problem exists for such persons when they need or wish to move from the floor to an upright position, or vice-versa. An individual may have fallen or may have voluntarily moved to a sitting position on the floor and have a difficult time getting back to an upright position so they may stand up. A fall is an obvious situation, but other situations exist that can be embarrassing for a person who is disabled, for instance, where a person has voluntarily placed him or herself down on the floor to play with grandchildren, but cannot get back up without assistance. Also, there are situations where it is desirable to move in a controlled manner, gradually from a standing position down to the floor. A device is also needed that will assist attendants and helpers to move a disabled person who is located on the floor and wants to stand up, or vice-versa. The task of moving a patient from the floor to an upright position can be extremely difficult for one person, particularly considering frailty and or weight factors for a particular patient.

There are a variety of technologies that have attempted to assist with individual mobility, however, the existing technologies either do not deal with the specific problem, or they employ means to deal with the problems that are inadequate because they are either excessively complicated, bulky, expensive or difficult to use. Other patents focused on improving personal mobility include: U.S. Pat. No. 6,070,278 (1996) to Smith (a hydraulic powered chair for use in a swimming pool); U.S. Pat. No. 5,802,638 (1998) to Parker (a hydraulic chair-bed); U.S. Pat. No. 5,484,151 (1996) to Tholkes (a mobile standing aid that moves a person from seated to standing position); U.S. Pat. No. 5,341,525 (1994) to Tillman (a shower lounge chair); U.S. Pat. No. 5,800,016 (1998) to Allred (a elevating, motorized chair); U.S. Pat. No. 4,420,286 (1983) to Hanson (a vehicle mounted invalid lift apparatus); U.S. Pat. No. 6,276,007B1 (2001) to Brown (a pole styled lift device); U.S. Pat. No. 5,189,741 (1993) to Beardmore (a device for standing up a sitting person from a seated position); U.S. Pat. No. 5,327,592 to Stump (a stationary patient lift that relies on a hoist apparatus to lift disabled persons); U.S. Pat. No. 5,802,633 (1998) to Capaldi (hoist apparatus); and U.S. Pat. No. 5,090,072 (1992) issued to Gray (a similar belt styled device). All of these various features and noble inventions may assist to move disabled persons, however, they use different means, frequently complicated hoist mechanisms, gears, chains, or guiding frames that are not suitable for everyday use, or that do not directly address the issue of moving a patient to and from a position on the floor. The inventor has solved many of the observed problems with a new lift apparatus disclosed herein.

### SUMMARY OF THE INVENTION

Accordingly, it is the objective of the present invention to provide a novel lift apparatus that simplifies the life of disabled persons and their attendants by providing an apparatus that easily raises and lowers ambulatory or other individuals from the floor to an upright position and vice-versa. The personal lift apparatus of the present invention features a first frame and a second frame, where the second frame features a seat that is preferably lifted hydraulically or pneumatically from a position on the floor to an upright position where the user may stand up.

It is a further object of the present invention to provide a personal lift apparatus that is easy to operate and with minimal moving parts.

It is an object of the present invention to provide a personal lift apparatus that moves a person from the floor to an upright position and vice versa.

It is a further object of the present invention to provide a lift apparatus that is operable by either a disabled person or by an attendant who is assisting the disabled person, and which may also preferably feature wheels for easy maneuverability.

It is a further object of the present invention to provide a lift apparatus that may be actuated by a control panel on the apparatus frame, or by wireless or wired remote control.

It is a further object of the present invention to provide a lift apparatus with a lifting function that is preferably powered by pneumatic or hydraulic means. Other objectives of the invention will become apparent to those skilled in the art once the invention has been shown and described.

### BRIEF DESCRIPTION OF THE DRAWING

The manner in which these objectives and other desirable characteristics can be obtained is explained in the following description and attached drawings in which:

FIG. 1 is a perspective view of the personal lift apparatus situated in a lowermost position with a seat near the floor.

FIG. 2 is a frontal perspective view of the personal lift apparatus during operation where the frame and seat are raised to an uppermost position.

It is to be noted, however, that the appended drawings illustrate only typical embodiments of this invention and are therefore not to be considered limiting of its scope, for the invention may admit to other equally effective embodiments.

### DETAILED DESCRIPTION OF THE INVENTION

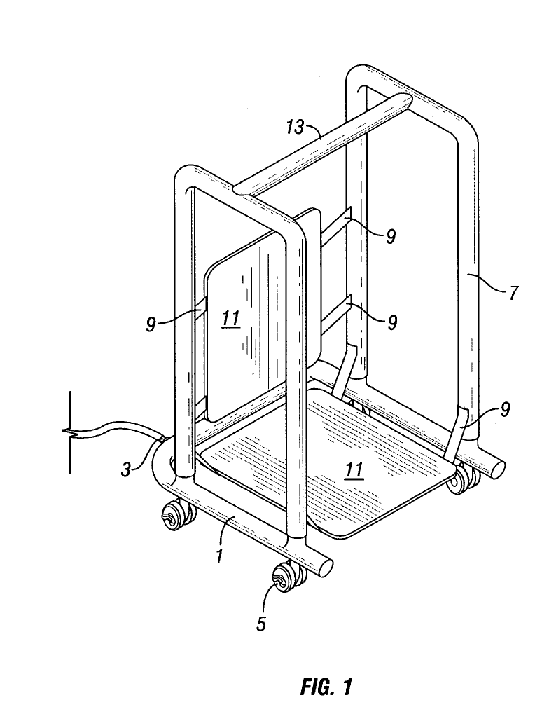

FIG. 1 is a perspective view of the personal lift apparatus as it appears in a lowered position. In this lowered position, a disabled person who finds him or herself on the floor, but unable to stand up, can maneuver to the apparatus and into the seat. Once situated in the seat, the person using the apparatus engages the apparatus so that it moves upward to a position where standing is feasible. This is a very common problem for individuals who are ambulatory, but who made have difficulty moving from a position on the floor to an upright position, and vice versa. The personal lift apparatus features a lower frame 1 and an upper frame 7. The upper frame 7 preferably fits over the lower frame 1 so that when the apparatus is lifting, the upper frame 7 is pushed upwards in a sliding motion over the lower frame 1. The upper frame 7 moves upward until the user stops the lifting action via a user control 12, or until the upper frame 7 reaches a terminal height, which is determined by a predetermined stop point. The stop point is preferably defined by a block fixed along the top portion of the lower frame 1 or the lower portion of the upper frame 7 or a combination of the same. The upper 7 and lower 1 frames are preferably adapted to interface closely with one another for smooth, sturdy and strong upward and downward motion. The preferable embodiment featured in FIG. 1 shows a lower frame 1 featuring a U-shape horizontal to the ground and four hollow perpendicular support members extending therefrom, each of which four supports are adapted to fit into four corresponding upper frame 7 members that move upward over the lower frame 1. An upper frame 7 featuring four separate corresponding members on the upper and lower frames is preferable for ease of motion and for supporting substantial weight. A U-shape on the bottom frame 1 is preferable in terms of ease of ingress for a user on the ground, so that it will not be necessary to hurdle a frame component to access the lift apparatus. The upper frame 7 and lower frame 1 are preferably hollow, permitting the flow of air inside the system. A preferable stabilizer 13 is depicted in FIG. 1. This stabilizer 13 keeps the upper frame sturdy during use, and may optionally have fluid connection with the air or liquid passing through the upper frame 7. The stabilizer 13 is also preferably useful as a handlebar for the user to stand up once the seat 11 is raised. The lift apparatus features a seat 11, which is fixedly mounted by connectors 9 to the upper frame 7 of the lift apparatus. In this manner, when the upper frame 7 moves, the seat 11 also moves either upward or downward, including a passenger if there is a passenger. A variety of seats 11 may be suitable for the lift apparatus, but the inventor has found useful and preferable a seat that features a separate back support. At its lowest point, the seat (lower portion) is situated close to the ground, for easy access, preferably in the range of zero (0) inches to six (6) inches above the ground. Because the seat 11 and lift apparatus are adapted principally to accommodate persons who may have difficulty moving, it is preferable that the seat 11 be maneuverable to a very low point, including resting on ground. A user may need to roll onto the seat 11 from a position on the ground. A slick seat 11 is also preferable to minimize friction coefficients and to help the user, who is frequently disabled, slide onto the seat. Considering a static friction coefficient (m) between two surfaces defined as the ratio of tangential force (F) required to produce sliding divided by the normal force between the surfaces (N), expressed as m=F/N, the given seat 11 should be “slick” enough so that the seat surface and surface of the user preferably have a static friction coefficient range of 0.04 to 1.5. Teflon surfaces, polished plastic or metal surfaces are also preferable for seat 11 to create a seat that is slick enough to permit a user ease of access to slide on to the seat 11. A tapered front to the seat 11 is also preferable to prevent snagging of clothing. The seat base, at its highest point is preferably in the range of 3 foot to 5 foot above ground when the lift apparatus is at a terminal height. A variety of materials may be preferably used to connect the seat 11 to the upper frame 7, the inventor having found connectors 9 made from nylon straps to be one such preference—having strength, and yet no sharp edges to obstruct or complicate a person getting into the lift apparatus. The lower frame 1 preferably features wheels 5 fixed to the frame to permit easy transportability and maneuverability of the lift apparatus. In this manner, the apparatus may be easily moved by or toward the physically disabled person. Similarly, wheels permit movement of the whole apparatus while carrying a person. Wheels may additionally feature a preferable locking feature so that the whole apparatus may be firmly stabilized once it is ideally positioned for use.

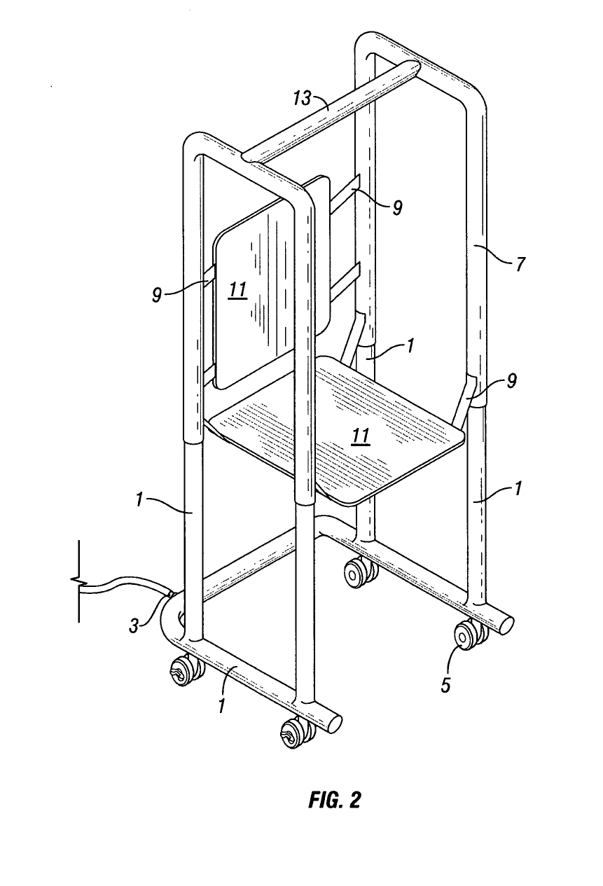

The upward action of the lift chair is accomplished by pneumatic or hydraulic means. FIG. 1 depicts a pneumatic embodiment of the present invention where pressurized air is introduced into the lift apparatus through a valve 3. In FIG. 1, the preferable entry point for pressurized air is valve 3 situated along the lower frame 1. Preferably, a hose connects valve 3 to an air compressor. A variety of commercially available air compressors may be used, with the principal functionality being the introduction of pressurized air into the lift apparatus. Commercial available “quiet” or “silent” compressors are preferable so as not to startle the operator or draw additional attention to use of the device. Pressurized air introduced into the lower frame 1 causes air pressure to build in the lift apparatus, thereby causing the upper frame 7 to be pushed upward until it reaches a uppermost position as depicted in FIG. 2. The upper 7 and lower 1 frames are preferably adapted to operate as a closed system to maintain lift function, and so that air introduced into the system is retained and may be released in a controlled manner and lift function precisely controlled. The upper 7 and lower 1 frames employ seals to prevent uncontrolled release of air, which seals are preferably located where the upper 7 and lower 1 frames meet. These seals may be made from commonly known materials, including but not limited to silicon, rubber, synthetic rubbers or plastics. The lift apparatus is preferably airtight, or substantially airtight, so that lift is maintained and so air is released in a controlled manner, slowly, or at the user's discretion through a pressure release, or through the valve 3. A stop mechanism is preferably built at the lower portion of the member(s) of upper frame 7, and at corresponding upper portion of the member(s) of lower frame 1. This stop mechanism is preferably of interlocking design, meaning that a lower portion of upper frame 7 envelops and interlocks with an uppermost portion of lower frame 1. In the pneumatic embodiment of this invention, this stop mechanism prevents the upper 7 and lower 1 frames from separating when the lift apparatus is in an expanded, elevated position as shown in FIG. 2. The upper 7 and lower 1 frames are preferably made of metals, or plastics, including but not limited to polyethylene, polypropylene, PVC, polyacrylic or any other plastics that can form rigid shapes. Preferably, the upper 7 and lower 1 frames are composed of hollow materials having an interior diameter in the range of 1 to 10 inches in width. The featured embodiment has a plurality (four) support members on the respective upper 7 and lower 1 frames to maximally distribute weight, however, the lift apparatus may operate with fewer than four. The lift apparatus can function preferably with at least one upper frame 7 support member and one corresponding lower 1 frame support member. The inventor similarly contemplates that commonly known hydraulic means may also be used to raise and lower the upper 7 and lower 1 frames of the lift apparatus. In place of an air compressor, a hydraulic pump can be used to supply hydraulic fluid to a cylinder that applies pressure and adjusts the height of hydraulic cylinders causing an upper frame 7 to raise or lower.

The lift apparatus features a user control 12 to actuate the operation of the lift. The user control 12 is preferably mounted on the lift apparatus upper 7 or lower 1 frame and features controls to cause the lift apparatus to move upward, move downward (by release of air or hydraulic pressure), or to stop. A user control 12 is also preferably featured on a wireless remote or on a wired remote. A remote control is a useful preference allowing a person to move the lift apparatus up or down without having to stand or be near the apparatus. In other words, if a disabled person is on the floor and cannot get up, a remote user control 12 permits the floor-bound person to move the lift into a position where the user may get on the lift.

It is to be noted, however, that the appended drawings illustrate only typical embodiments of this invention and are therefore not to be considered limiting of its scope, for the invention may admit to other equally effective embodiments which are appreciated by those skillful in the arts.

I claim:

1. A personal lift apparatus comprising:
(a) An upper frame;
(b) said upper frame connected to and slidable over a lower frame;
(c) a seat fixedly connected to said upper frame by a plurality of connectors;
(d) said upper and lower frames in fluid connection with a pressurized air source and adapted so that pressurized air causes raising and lowering of said upper frame; and,
(e) whereby a person may be raised and lowered from a position on the floor to an upright position once situated in said seat.

2. The personal lift apparatus of claim 1, wherein said upper frame is defined by at least one vertical member and wherein said lower frame is defined by at least one corresponding vertical member.

3. The personal lift apparatus of claim 1, wherein said lower frame is defined by a U-shaped base component, with a plurality of vertical members extending upward therefrom, and wherein said upper frame is defined by a plurality of corresponding downwardly extending vertical members.

4. The personal lift apparatus of claim 1, wherein said pressurized air source is an air compressor.

5. The personal lift apparatus of claim 4 wherein said pressurized air is supplied through a valve into said lower frame.

6. The personal lift apparatus of claim 1, wherein said seat is slick to permit easy access to a user.

7. The personal lift apparatus of claim 1, wherein said seat at a lowermost position is in the range of 1/16^{th} inch to 3 inches above ground.

8. The personal lift apparatus of claim 1, wherein said seat at an uppermost position is in the range of 3 to 5 feet above ground.

9. The personal lift apparatus of claim 1, wherein upper and lower frames are formed from any of the group of materials consisting of metal, PVC, polypropylene, polyethylene, polyacrylics, and plastics capable of forming rigid shapes.

10. The personal lift apparatus of claim 1, further comprising a user control, whereby the lift may be directed upward, downward, or stopped.

11. The personal lift apparatus of claim 1, wherein upper and lower frames have interior diameters in the range of 1 to 10 inches.

12. The personal lift apparatus of claim 1, wherein said lower frame features a plurality of wheels.

13. The personal lift apparatus of claim 1, wherein said upper frame further comprises a stabilizer bar.

14. A personal lift apparatus comprising:
(a) An upper frame and a lower frame;
(b) Said upper frame having a seat fixedly connected to said upper frame by a plurality of connectors;
(c) said upper and lower frames hydraulically connected so that said upper frame may be hydraulically raised and lowered; and,
(d) whereby a person may be raised and lowered from a position on the floor to an upright position once situated in said seat.
